(19) United States
(12) Patent Application Publication
(10) Pub. No.: US 2010/0329424 A1
(43) Pub. Date: Dec. 30, 2010

(54) X-RAY DIFFRACTION IMAGING SYSTEM AND METHOD FOR OPERATING THE SAME

(76) Inventors: Geoffrey Harding, Hamburg (DE); Stephan Olesinski, Hamburg (DE); Dirk Kosciesza, Pinneberg (DE); Helmut Rudolf Otto Strecker, Hamburg (DE)

Correspondence Address: PATRICK W. RASCHE (22697);ARMSTRONG TEASDALE LLP, 7700 Forsyth Boulevard, Suite 1800, St. Louis, MO, 63105, US

(21) Appl. No.: 12/494,810

(22) Filed: Jun. 30, 2009

(51) Int. Cl. G01N 23/20; G01N 23/201

(52) U.S. Cl. 378/71; 378/88

(57) ABSTRACT

A method for operating an X-ray diffraction imaging (XDI) system to scan an object includes generating an X-ray beam from at least one source focus at a first focus location, and receiving first scatter radiation at a first scatter angle at a scatter detector. The first scatter radiation is produced when the X-ray beam interacts with the object. The method further includes displacing the at least one source focus from the first focus location to a second focus location, generating a displaced X-ray beam from the at least one source focus at the second focus location, and receiving second scatter radiation at a second scatter angle at the scatter detector. The second scatter radiation is produced when the displaced X-ray beam interacts with the object. An identification of the object based on one of the first scatter radiation and the second scatter radiation is output.

### BACKGROUND OF THE INVENTION

1. Field of the Invention

The embodiments described herein relate generally to X-ray diffraction imaging systems and, more particularly, to scatter angles used in X-ray diffraction imaging systems.

2. Description of Related Art

At least some known X-ray diffraction imaging (XDI) systems are used to identify a material being scanned by detecting radiation scattered by the material. Known fixed angle energy dispersive XDI systems are restricted to detecting X-ray scatter at only a single angle of scatter radiation and, thus, are limited to acquiring momenta values within a fixed range. The angle of scatter, or scatter angle, represents a scaling factor between an X-ray diffraction profile and a photon energy spectrum and, as such, the fixed scatter angle is selected to give results for a relatively large variety of materials, such as the typical contents of luggage. However, in many situations a scatter angle other than the fixed scatter angle may provide better results for identifying the material.

It is desirable to provide an XDI system that can acquire scatter radiation data at more than one scatter angle.

### BRIEF SUMMARY OF THE INVENTION

In one aspect, a method for operating an X-ray diffraction imaging (XDI) system to scan an object is provided. The XDI system includes an X-ray source having at least one source focus and a scatter detector. The method includes generating an X-ray beam from the at least one source focus at a first focus location, and receiving first scatter radiation at a first scatter angle at the scatter detector. The first scatter radiation is produced when the X-ray beam interacts with the object. The method further includes displacing the at least one source focus from the first focus location to a second focus location, generating a displaced X-ray beam from the at least one source focus at the second focus location, and receiving second scatter radiation at a second scatter angle at the scatter detector. The second scatter radiation is produced when the displaced X-ray beam interacts with the object. An identification of the object based on at least one of the first scatter radiation and the second scatter radiation is output.

In another aspect, an X-ray diffraction imaging (XDI) system is provided. The XDI system includes an X-ray source including at least one source focus, a scatter detector including at least one detector point, and a control system coupled in communication with the X-ray source and the scatter detector. The control system is configured to generate an X-ray beam from the at least one source focus at a first focus location to produce first scatter radiation at a first scatter angle when the X-ray beam interacts with an object, displace the at least one source focus from the first focus location to a second focus location, and generate a displaced X-ray beam from the at least one source focus at the second focus location to produce second scatter radiation at a second scatter angle when the displaced X-ray beam interacts with the object.

The embodiments described herein provide an XDI system having a source focus that can be displaced to adjust a scatter angle at which scatter radiation is received at a scatter detector. As such, the embodiments described herein enable scatter radiation data to be acquired at more than one scatter angle.

### BRIEF DESCRIPTION OF THE DRAWINGS

FIGS. 1-4 show exemplary embodiments of the system and method described herein.

FIG. 1 is a schematic perspective view of an exemplary X-ray diffraction imaging (XDI) system in a first configuration.

FIG. 2 is a schematic perspective view of the XDI system shown in FIG. 1 in a second configuration.

FIG. 3 is a schematic side view of the XDI system shown in FIG. 1 in the second configuration.

FIG. 4 is a flowchart of a method for operating the XDI system shown in FIGS. 1-3.

### DETAILED DESCRIPTION OF THE INVENTION

The embodiments described herein provide a multi-inverse fan beam (MIFB) X-ray diffraction imaging (XDI) system having an adjustable scatter angle. More specifically, rather than having a fixed scatter angle as in known XDI systems, the XDI system described herein has a scatter angle that can be dynamically adapted to local properties of an object under investigation. Such adjustment and/or adaption can be based on a feed-back loop between local measured scatter properties and a deflection voltage of a magnetically and/or electrostatically deflected scanning beam digital X-ray source (SBDX). Alternatively, a variation in scatter angle can be achieved using an X-ray multisource that includes a two-dimensional (2D) array of discrete electron emitters, each of which can be selectively activated by means of an applied grid voltage. Moreover, scatter angle adaption is also possible using a one-dimensional (1D) X-ray multisource that has a number of discrete electron emitters arranged on a linear array. In such a 1D array, each of the electron emitters is provided with its own electrostatic or magnetic deflection arrangement. An X-ray multisource that is capable of varying the scatter angle by deflecting an electron beam, by switching on or off a discrete electron emitter, and/or by using some combination of techniques is referred to herein as a Multi-Focus X-ray Source (MFXS).

Further, the embodiments described herein provide an XDI system having a variable angle of scatter, which can depend on local properties of an object being scanned. As such, a higher energy spectrum at a smaller value scatter angle can be used for analyzing dense materials within an object, and less dense materials within an object can be analyzed using a lower energy spectrum at a higher value scatter angle. Moreover, regions of an object having amorphous and/or liquid contents can also be measured with the higher value scatter angle. In one embodiment, the XDI system described herein is used for scanning objects, such as luggage and/or bags, in a transportation setting, such as an airport, depot, and/or port.

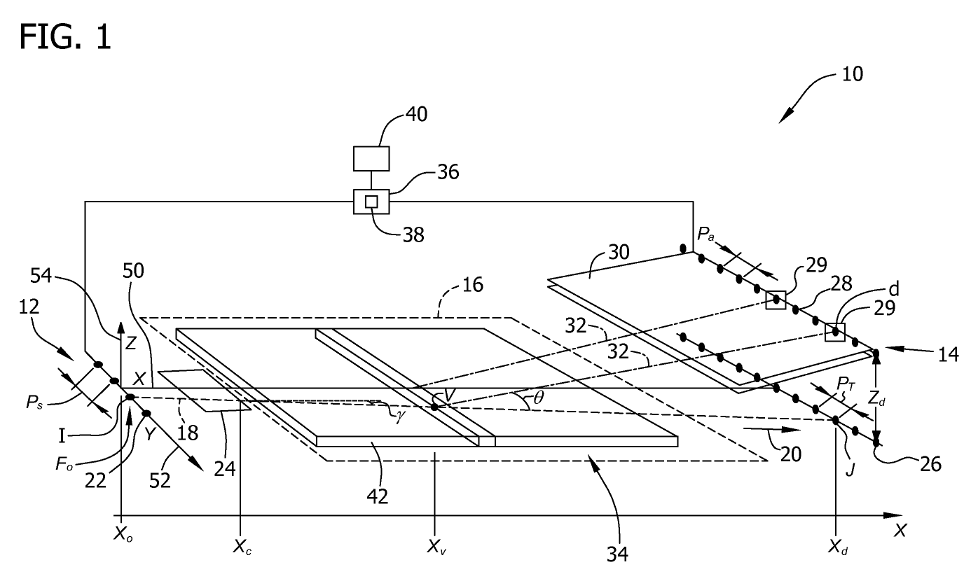

FIG. 1 shows a schematic perspective view of an exemplary X-ray diffraction imaging (XDI) system 10 in a first configuration. XDI system 10 includes an X-ray source 12, a scatter detector 14, and an examination area 16 defined between X-ray source 12 and scatter detector 14. It should be understood that XDI system 10 can also include a transmission detector (not shown).

In the exemplary embodiment, X-ray source 12 is a Multi-Focus X-ray Source (MFXS). More specifically, X-ray source 12 is configured to emit an X-ray beam 18 along an X-axis 50 such that a direction 20 of X-ray beam 18 is substantially parallel to X-axis 50. In the exemplary embodiment, X-ray beam 18 is oriented at an in-plane angle γ with respect to X-axis 50, wherein angle γ has a magnitude such that X-ray beam 18 is substantially parallel to X-axis 50. For example, a maximum magnitude of angle γ is about ±300 relative to X-axis 50, wherein angle γ changes depending on a position of at least one source focus 22 and a position of at least one target point, which is described in more detail below. A mean value of angle γ, which is an average value of angle γ over all source foci and target points, approaches approximately 0°. As such, X-ray beam 18 is substantially parallel to X-axis 50 due to the relatively small magnitude of angle γ. In such an example, angle γ is also, on average, substantially equal to 0°.

X-ray source 12 includes at least one source focus 22. In the exemplary embodiment, X-ray source 12 includes a plurality of discrete source foci 22 located on a Y-axis 52 that can be sequentially activated to emit X-ray beam 18. As such, X-ray source 12 scans in a direction substantially perpendicular to direction 20 of X-ray beam 18. Source foci 22 are spaced apart along Y-axis 52 at a pitch Pₛ. In the exemplary embodiment, X-ray source 12 is configured to displace at least one source focus 22 from Y-axis 52 in a Z-direction, as described below. Further, X-ray source 12 includes a primary collimator 24 configured to generate a multiple inverse fan beam (MIFB). Primary collimator 24 is configured to direct X-ray beam 18 to a target point 26, as described in more detail below.

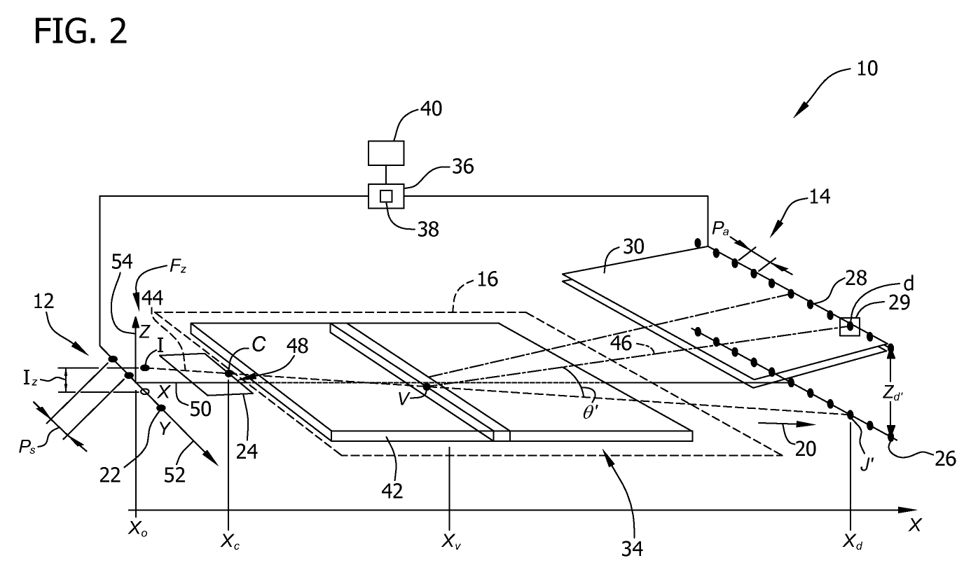

Scatter detector 14 is a one-dimensional or two-dimensional pixellated detector array in the exemplary embodiment. Alternatively, scatter detector 14 includes a plurality of strips (not shown). In the exemplary embodiment, scatter detector 14 extends either along Y-axis 52 or along Y-axis 52 and a Z-axis 54 and includes at least one detector point 28. In one embodiment, a detector element 29 is located at each detector point 28 of scatter detector 14. In the exemplary embodiment, a plurality of detector points 28 are defined along scatter detector 14 substantially parallel to Y-axis 52, and detector element 29 is located at each detector point 28. Detector points 28 are spaced at a pitch P_{d}. A secondary collimator 30 is positioned between examination area 16 and scatter detector 14 to facilitate ensuring that only scatter radiation 32 at a scatter angle θ between scatter radiation 32 and X-ray beam 18 is able to reach scatter detector 14 for detection. In the exemplary embodiment, secondary collimator 30 is a fixed angle secondary collimator (FASC) that has a transmission profile defining a series of parallel planes, or channels, along which scatter radiation 32 at scatter angle θ with respect to an X-Y plane is allowed to reach scatter detector 14. Although only a single channel is shown in FIGS. 1 and 2, it should be understood that secondary collimator 30 includes any suitable number of channels that enable XDI system 10 to function as described herein.

At least one target point 26 is defined in the X-Y plane. In the exemplary embodiment, a plurality of target points 26 are defined in an X-Y plane and extend substantially parallel to detector points 28 along Y-axis 52. Target points 26 are points that X-ray beam 18 will intersect with no object 34 positioned in examination area 16 to cause scattering of X-ray beam 18. As such, each target point 26 is offset in the Z-direction from a respective detector point 28 by a distance Z_{d}. In the exemplary embodiment, target points 26 are fixed and have a constant pitch P_{T} that is substantially equal to pitch P_{d}.

A control system 36 is operationally coupled to, such as in operational control communication with, X-ray source 12 and scatter detector 14. As used herein, “operational control communication” refers to a link, such as a conductor, a wire, and/or a data link, between two or more components of XDI system 10 that enables signals, electric currents, and/or commands to be communicated between the two or more components. The link is configured to enable one component to control an operation of another component of XDI system 10 using the communicated signals, electric currents, and/or commands.

Further, control system 36 is shown as being one device, however control system 36 may be a distributed system throughout XDI system 10, an area surrounding XDI system 10, and/or at a remote control center. Control system 36 includes a processor 38 configured to perform the methods and/or steps described herein. Further, many of the other components described herein include a processor. As used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or control system can also include memory, input channels, and/or output channels.

In the embodiments described herein, memory may include, without limitation, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, input channels may include, without limitation, sensors and/or computer peripherals associated with an operator interface, such as a mouse and a keyboard. Further, in the exemplary embodiment, output channels may include, without limitation, a control device, an operator interface monitor and/or a display. In the exemplary embodiment, control system 36 is operationally coupled to a display device 40 for displaying an image, such as an X-ray diffraction image, generated using the methods and systems described herein.

Processors described herein process information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, and/or a distributed control system. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, imaging system control commands. The execution of sequences of instructions is not limited to any specific combination of hardware circuitry and software instructions.

Referring further to FIG. 1, during an operation of XDI system 10, X-ray source 12 performs a two-dimensional (2D) scan of an X-Y section 42 of object 34 by sequentially activating source foci 22 along a length of X-Y section 42. More specifically, primary collimator 24 is configured to transmit a plurality of collimated X-ray beams 18 from each source focus 22 toward a corresponding target point 26 in the X-Y plane. When X-ray beam 18 passes through object 34, radiation is scattered from points within object 34 to produce scatter radiation, such as scatter radiation 32, at a plurality of scatter angles, including scatter angle θ.

Secondary collimator 30 collimates the scatter radiation such that only scatter radiation 32 at substantially scatter angle θ reaches scatter detector 14. Scatter detector 14 detects scatter radiation 32 and transmits scatter radiation data to control system 36 for further processing. As such, coherent scatter induced in object 34 along paths of the plurality of X-ray beams 18 is recorded by scatter detector 14 and/or control system 36. In the exemplary embodiment, control system 36 is configured to perform an energy analysis of scatter radiation arriving at scatter detector 14 to yield an X-ray diffraction (XRD) profile of profile of a scatter point V of object 34. It should be understood that one or more scatter regions of object 34 can be simultaneously investigated when detector 14 is extended in the Z-direction and includes separate detector elements. In an energy analysis, a conversion between photon energy E and momentum transfer p is given in the following equation:

$$p = \frac{E}{hc} \cdot sin ( \frac{θ}{2} ) , \qquad ( Equation 1 )$$

where p is the momentum transfer, E is the photon energy, h is Planck's constant, c is the speed of light, and θ is the angle of scatter radiation. In the exemplary embodiment, scatter angle θ is a relatively small angle when XDI system 10 is in the first configuration.

To determine scatter angle θ from the configuration of XDI system 10, assume that X-ray beam 18 is emitted from a source focus I toward a target point J and that X-ray beam 18 interacts with a scatter point V within object 34 to generate scatter radiation 32 that is received at detector element 29 positioned at a detector point d. As such, in-plane angle γ is defined as an angle between X-axis 50 and X-ray beam 18 from source focus I to target point J and is given by the equation:

$$tan γ = \frac{( J - \frac{{J}_{max} + 1}{2} ) \cdot {P}_{d} - ( I - \frac{{I}_{max} + 1}{2} ) \cdot {P}_{s}}{{X}_{d}} , \qquad ( Equation 2 )$$

where γ is an angle in the X-Y plane, J is a target point of the plurality of target points 26, Jₘₐₓ is a total number of target points 26, P_{d} is a pitch of scatter detector 14, I is a source focus of the plurality of source foci 22, Iₘₐₓ is a total number of source foci 22, Pₛ is a pitch of X-ray source 12, and X_{d} is an X-position of a target point of the plurality of target points 26.

A distance along X-axis 50 from scatter point V to a plane in which scatter detector is located is given by the equation:

$${X}_{V} = {X}_{d} - \frac{{Z}_{d}}{tan θ} , \qquad ( Equation 3 )$$

where X_{V} is an X-position of scatter point V, X_{d} is an X-position of target point J, Z_{d} is a distance between a detector point d of the plurality of detector points 28 and a respective target point J, and θ is the angle of scatter radiation 32. Accordingly, scatter angle θ is given by the following equation when XDI system 10 is in the first configuration:

$$θ ≅ {tan}^{- 1} \{ \frac{{Z}_{d} cos γ}{{X}_{V}} \} , \qquad ( Equation 4 )$$

where θ is the angle of scatter radiation 32, Z_{d} is a distance between the detector point d and a respective target point J, γ is the in-plane angle, and X_{V} is the X-position of scatter point V.

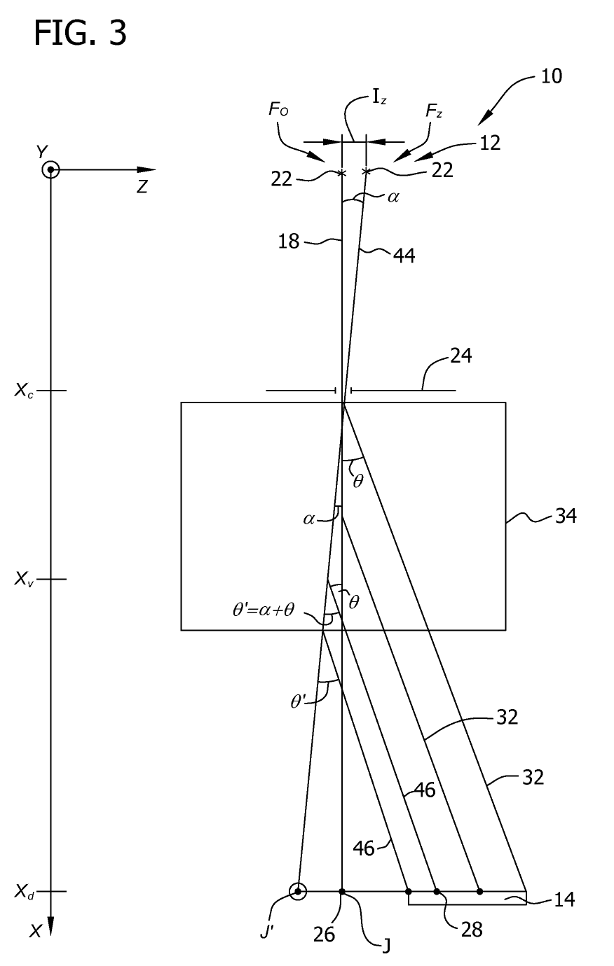

In the exemplary embodiment, a choice of scatter angle θ of XDI system 10 by control system 36 and/or an operator takes into consideration at least two factors. The first factor is that a relatively small value of scatter angle θ corresponds to a high photon energy E at a constant momentum transfer p as shown by Equation 1. Using the relatively small value of scatter angle θ is advantageous when scanning relatively dense objects, which requires the use of energetic photons for adequate transmission. The second factor is that a scatter signal at a constant peak resolution in a diffraction profile increases when the value of scatter angle θ increases. As such, for less dense objects, or regions of an object which are relatively radiation-transparent, it would be advantageous to use a larger value of scatter angle θ. Moreover, detection and/or identification of liquid and/or amorphous materials within object 34 generally requires an XRD profile to be measured over a wider range of momentum values than a range used for detecting and/or identifying a crystalline material. Accordingly, scatter angle θ of XDI system 10 is adjustable to a second scatter angle θ′ to perform measurements and/or data acquisition at a plurality of values of scatter angle θ. More specifically, to adjust scatter angle θ to scatter angle θ′, XDI system 10 is adjusted from the first configuration, shown in FIG. 1, to a second configuration, shown in FIGS. 2 and 3.

FIG. 2 is a schematic perspective view of XDI system 10 in the second configuration. FIG. 3 is a schematic side view of XDI system 10 in the second configuration.

In the second configuration, at least one source focus 22 has been displaced from Y-axis 52. In the exemplary embodiment, source focus 22, such as source focus I, is displaced to generate a displaced X-ray beam 44. In the second configuration, source focus I is displaced a distance I_{z} in the Z-direction while retaining its Y-coordinate. As such, displaced X-ray beam 44 is at a displacement angle α to X-ray beam 18. Accordingly, displaced X-ray beam 44 is directed to a displaced target point J′, which is spaced a distance Z_{d}′ from detector point d.

When displaced X-ray beam 44 is emitted from source focus I, displaced X-ray beam 44 passes through primary collimator 24 and exits primary collimator 24 at a point C. Point C has an X-coordinate of X_{C} and a Z-coordinate of approximately 0 (zero). X-coordinate, or X-position of point C, X_{C} is measured from a plane of source foci 22. Upon interacting with object 34 at a point, such as scatter point V, radiation from displaced X-ray beam 44 is scattered to produce scatter radiation 46. Because source focus I has been displaced, secondary collimator 30 allows only scatter radiation 46 at second scatter angle θ′ to reach scatter detector 14.

Using the assumptions set forth above regarding FIG. 1, second scatter angle θ′ of XDI system 10 in the second configuration can be determined using the following equations:

$$\begin{matrix}{θ}^{′} ≅ {tan}^{- 1} \{ cos γ \cdot ( θ + α ) \} , where & ( Equation 5 ) \\ θ = \frac{{Z}_{d}^{′}}{{X}_{V}} , \\ and & ( Equation 6 ) \\ α = \frac{{I}_{Z}}{{X}_{C}} . & ( Equation 7 )\end{matrix}$$

In Equations 5-7, θ′ is the second scatter angle, γ is the in-plane angle (shown in FIG. 1), Z_{d}′ is a distance between detector point d and a respective target point J′, X_{V} is the X-position of scatter point V, I_{Z} is the displacement of source focus I from Y-axis 52, and X_{C} is the X-position of an exit 48 of primary collimator 24. When a desired value for second scatter angle θ′ is known, Equations 5-7 can be used to determine displacement I_{Z} of source focus I.

During operation of XDI system 10, control system 36 controls X-ray source 12 and/or scatter detector 14 to generate X-ray beam 18 from source focus I at a first focus location F₀. Scatter radiation 32 is produced at scatter angle θ when X-ray beam 18 interacts with object 34. Control system 36 displaces source focus I from first focus location F₀ to a second focus location F_{Z}, and generates displaced X-ray beam 44 from source focus I at second focus location F_{Z}. Scatter radiation 46 is produced at second scatter angle θ′ when displaced X-ray beam 44 interacts with object 34. In the exemplary embodiment, control system 36 determines second scatter angle θ′ using data acquired from scatter radiation 46. More specifically, control system 36 inputs a property of object 34, as determined from scatter radiation 32 and/or scatter radiation 46, into a feed-back loop to determine second scatter angle θ′.

By displacing at least one source focus 22 as described above, a scatter angle of XDI system 10 can be dynamically adapted to local scattering properties of object 34. Further, to achieve such an adaption and/or adjustment, only source focus 22 is displaced without the need to adjust any other components of XDI system 10. In one embodiment, when scatter angle θ is generally small, on the order of about 40 milliradians, a displacement I_{Z} of source I is relatively small. As such, when XDI system 10 has a collimator exit point C at an X-position X_{C} of about 650 millimeters (mm) and has about 25% variation in scatter angle, the ratio I_{Z}/X_{C} is equal to approximately ±0.005. Accordingly, displacement distance I_{Z} would have a value of about 3.25 mm. Such a value for distance I_{Z} facilitates ensuring that a primary X-ray beam, such as X-ray beam 18 and/or displaced X-ray beam 44, can be monitored by a transmission detector (not shown) when XDI system 10 includes a transmission detector. In one embodiment, the transmission detector is included in XDI system 10 to facilitate correcting for attenuation effects.

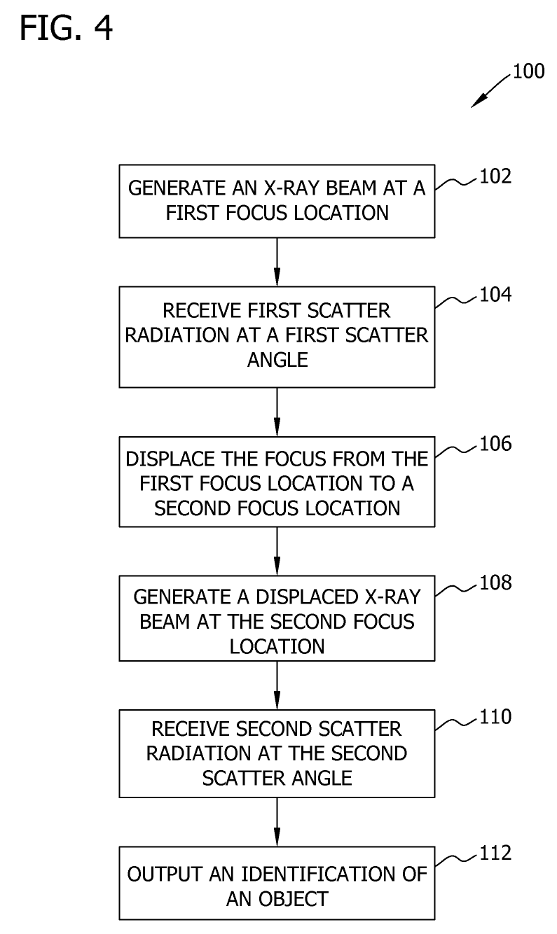

FIG. 4 is a flowchart of a method 100 for operating XDI system 10 (shown in FIGS. 1-3). By performing method 100, a scatter angle of XDI system 10 is adjusted from a first scatter angle to at least a second scatter angle. Method 100 is performed by control system 36 (shown in FIGS. 1 and 2) sending commands and/or instructions to components of XDI system 10, such as X-ray source 12, scatter detector 14, and/or any other suitable component. Processor 38 (shown in FIGS. 1 and 2) within control system 36 is programmed with code segments configured to perform method 100. Alternatively, method 100 is encoded on a computer-readable medium that is readable by control system 36. In such an embodiment, control system 36 and/or processor 38 is configured to read computer-readable medium for performing method 100. In the exemplary embodiment, method 100 is performed for each object scanned. Alternatively, method 100 is performed upon request of an operator of XDI system 10 and/or when control system 36 determines method 100 is to be performed.

Referring to FIGS. 1-4, method 100 includes generating 102 X-ray beam 18 from source focus I at first focus location F₀. In the exemplary embodiment, when X-ray beam 18 is generated 102, X-ray beam 18 is directed to target point J of the plurality of target points 26. As described above, target point J corresponds to detector point d of the plurality of detector points 28. As X-ray beam 18 passes through object 34 and interacts with object 34 at scatter point V, scatter radiation 32 is produced. Scatter detector 14 receives 104 scatter radiation 32 at scatter angle θ. More specifically, radiation scattered at scatter point V is collimated by secondary collimator 30 such that scatter radiation 32 at scatter angle θ is received 104 by scatter detector 14.

Source focus I is displaced 106 from first focus location F₀ to second focus location F_{Z}. More specifically, in the exemplary embodiment, source focus I is displaced 106 in the Z-direction from first focus location F₀ to second focus location F_{Z} by a distance I_{Z}, as described above. In a particular embodiment, control system 36 dynamically adjusts a position of source focus I during a scan of object 34. In one embodiment, source focus I is displaced 106 based on a determination of second scatter angle θ′. More specifically, control system 36 is configured to determine second scatter angle θ using Equations 5-7, as described above. As such, source focus I is displaced 106 based on a configuration of XDI system 10.

Alternatively, source focus I is displaced 106 using a determination of second scatter angle θ based on received scatter radiation 32. In one embodiment, second scatter angle θ′ is determined by inputting received data of scatter radiation 32 into a feed-back loop of control system 36. The feed-back loop is, for example, a loop between at least one measured local scatter property of object 34 and a deflection voltage of X-ray source 12. The measured local scatter property is a property of object 34, such as a density of object 34 at X-Y section 42, a location of a peak in a scatter profile of object 34 at X-Y section 42, and/or a gradient of a high energy region of an XRD profile of object 34 at X-Y section 42. In one embodiment, control system 36 receives data regarding the measured local scatter property from scatter detector 14 and inputs the data into the feed-back loop. Results from the fee-back loop are then used by control system 36 to control a deflection voltage of X-ray source 12 to displace source focus I. A change in the deflection voltage of X-ray source 12 causes a change of a value of the measured local scatter property detected by scatter detector 14 and input into the feed-back loop. When density is used as the measured local scatter property, the density of object 34 is calculated using the received data of scatter radiation 32. Once second scatter angle θ′ is determined, displacement distance I_{Z} can be determined using Equations 5-7.

In the exemplary embodiment, after source focus I is displaced 106, displaced X-ray beam 44 is generated 108 from source focus I at second focus location F_{Z}. More specifically, displaced X-ray beam 44 is generated 108 by magnetically and/or electrostatically deflecting an electron beam from source focus I from first focus location F₀ to second focus location F_{Z}. As displaced X-ray beam 44 passes through object 34 and interacts with object 34 at scatter point V, scatter radiation 46 is produced. Scatter detector 14 receives 110 scatter radiation 46 at scatter angle θ′. More specifically, radiation scattered at scatter point V is collimated by secondary collimator 30 such that scatter radiation 46 at scatter angle θ′ is received 110 by scatter detector 14.

Control system 36 then uses data from scatter radiation 32 and/or scatter radiation 46 to identify a material within object 34. In the exemplary embodiment, selection of data from scatter radiation 32 and/or scatter radiation 46 is based on the factors set forth above to facilitate generating an accurate identification of object 34. For example, when object 34 is more dense, scatter radiation 32 is used when scatter angle θ is smaller than scatter angle θ′, and vice versa. In the exemplary embodiment, the identification of object 34 is performed by generating an XRD image of object 34 using scatter angle θ data from scatter radiation 32 and/or scatter radiation 46, and comparing the XRD image to X-ray diffraction profiles of known materials. Control system 36 then outputs 112 the identification of object 34 based on data from scatter radiation 32 and/or scatter radiation 46.

The above-described embodiments provide an XDI system that is based on a Multi-Focus X-ray Source and that dynamically allows measurement of XRD profiles utilizing varying angles of scatter. More specifically, by including an X-ray source that has a source focus that can be displaced, the scatter angle of scatter radiation received at the scatter detector can be varied. By using the embodiments described herein that are based on an adaptive momentum transfer concept, a useful range of momentum transfer that can be analyzed is increased. Further, the above-described embodiments enable an overall increase in a signal-to-noise ratio, which increases a measurement speed for an X-ray source having a constant tube power. Accordingly, the above-described XDI system has an enhanced detection rate and/or reduced false alarm rates with a wide variety of materials, as compared to fixed scatter angle XDI systems.

A technical effect of the system and method described herein includes at least one of: (a) generating an X-ray beam from at least one source focus at a first focus location; (b) receiving first scatter radiation at a first scatter angle at a scatter detector, wherein the first scatter radiation is produced when an X-ray beam interacts with an object; (c) displacing at least one source focus from a first focus location to a second focus location; (d) generating a displaced X-ray beam from at least one source focus at a second focus location; (e) receiving second scatter radiation at a second scatter angle at a scatter detector, wherein the second scatter radiation is produced when a displaced X-ray beam interacts with an object; and (f) outputting an identification of an object based on the first scatter radiation and/or second scatter radiation.

Exemplary embodiments of an X-ray diffraction imaging (XDI) system and method for operating the same are described above in detail. The method and system are not limited to the specific embodiments described herein, but rather, components of the system and/or steps of the method may be utilized independently and separately from other components and/or steps described herein. For example, the method may also be used in combination with other imaging systems and methods, and is not limited to practice with only the XDI system and method as described herein. Rather, the exemplary embodiment can be implemented and utilized in connection with many other imaging applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for operating an X-ray diffraction imaging (XDI) system to scan an object, the XDI system including an X-ray source having at least one source focus and a scatter detector, said method comprising:
generating an X-ray beam from the at least one source focus at a first focus location;
receiving first scatter radiation at a first scatter angle at the scatter detector, the first scatter radiation produced when the X-ray beam interacts with the object;
displacing the at least one source focus from the first focus location to a second focus location;
generating a displaced X-ray beam from the at least one source focus at the second focus location;
receiving second scatter radiation at a second scatter angle at the scatter detector, the second scatter radiation produced when the displaced X-ray beam interacts with the object; and
outputting an identification of the object based on at least one of the first scatter radiation and the second scatter radiation.

2. A method in accordance with claim 1, wherein displacing the at least one source focus from the first focus location to a second focus location comprises displacing the at least one source focus in a Z-direction from the first focus location, the first focus location on a Y-axis and the Z-direction substantially perpendicular to the Y-axis.

3. A method in accordance with claim 1, wherein generating a displaced X-ray beam from the at least one source focus at the second focus location comprises one of magnetically and electrostatically deflecting an electron beam from the at least one source focus from the first focus location to the second focus location.

4. A method in accordance with claim 1, wherein the scatter detector includes a plurality of detector points, and a plurality of target points in spaced relationship to the plurality of detector points, said generating an X-ray beam from the at least one source focus at a first focus location comprising directing the X-ray beam to a first target point of the plurality of target points, the first target point corresponding to a first detector point of the plurality of detector points.

5. A method in accordance with claim 1, wherein displacing the at least one source focus from the first focus location to a second focus location comprises determining the second scatter angle based on the detected first scatter radiation.

6. A method in accordance with claim 5, wherein determining the second scatter angle based on the detected first scatter radiation comprises inputting the detected first scatter radiation into a feed-back loop to determine the second scatter angle.

7. A method in accordance with claim 5, wherein determining the second scatter angle based on the detected first scatter radiation comprises determining the second scatter angle based on a density of the object calculated using the detected first scatter radiation.

8. A method in accordance with claim 1, wherein displacing the at least one source focus from the first focus location to a second focus location comprises dynamically adjusting a position of the at least one source focus during a scan of the object.

9. An X-ray diffraction imaging (XDI) system, comprising:
an X-ray source comprising at least one source focus;
a scatter detector comprising at least one detector point; and
a control system coupled in communication with said X-ray source and said scatter detector, said control system configured to:
generate an X-ray beam from said at least one source focus at a first focus location, first scatter radiation produced at a first scatter angle when the X-ray beam interacts with an object;
displace said at least one source focus from the first focus location to a second focus location; and
generate a displaced X-ray beam from the at least one source focus at the second focus location, second scatter radiation produced at a second scatter angle when the displaced X-ray beam interacts with the object.

10. An XDI system in accordance with claim 9, wherein said X-ray source comprises a plurality of source foci aligned along a Y-axis, said control system configured to sequentially activate each source focus of said plurality of source foci along the Y-axis.

11. An XDI system in accordance with claim 9, wherein said scatter detector comprises a plurality of detector points aligned along a Y-axis, said XDI system further comprising a plurality of target points aligned along the Y-axis at a distance in a Z-direction from said plurality of detector points, the Z-direction substantially perpendicular to the Y-axis.

12. An XDI system in accordance with claim 11, wherein said X-ray beam is directed to a first target point of said plurality of target points, and the first scatter radiation is received at a first detector point of said plurality of detector points, said first detector point corresponding to said first target point.

13. An XDI system in accordance with claim 9, further comprising a primary collimator positioned between said X-ray source and the object, said control system configured to determine the second scatter angle using the equation:
$${θ}^{′} ≅ {tan}^{- 1} \{ cos γ \cdot ( \frac{{Z}_{d}^{′}}{{X}_{V}} + \frac{{I}_{Z}}{{X}_{C}} ) \} ,$$
where
θ′ is the second scatter angle, y is an in-plane angle, I_{Z} is a displacement of said at least one source focus from a Y-axis which extends through said X-ray source, X_{V} is a position of a scatter point within the object with respect to an X-axis that is perpendicular to the Y-axis, Z_{d}′ is a distance between the at least one detector point and a respective target point that is in a plane of the X-axis, and X_{C} is a position of an exit of said primary collimator with respect to the X-axis.

14. An XDI system in accordance with claim 9, wherein said control system is configured to detect at least one of the first scatter radiation and the second scatter radiation at said scatter detector to identify the object.

15. An XDI system in accordance with claim 14, wherein said control system is further configured to determine the second scatter angle based on the first scatter radiation.

16. An XDI system in accordance with claim 14, wherein said control system is configured to input detected first scatter radiation into a feed-back loop to determine the second scatter angle.

17. An XDI system in accordance with claim 16, wherein said X-ray source is a magnetically deflected scanning beam digital X-ray source, said control system configured to:
receive measured local scatter property data from said scatter detector;
input the measured local scatter property data into the feed-back loop; and
control a deflection voltage of said X-ray source based on a result of the feed-back loop.

18. An XDI system in accordance with claim 14, wherein said control system is configured to determine the second scatter angle based on a density of the object calculated using the detected first scatter radiation.

19. An XDI system in accordance with claims 14, wherein said control system is configured to determine the second focus location based on the determined second scatter angle.

20. An XDI system in accordance with claim 19, further comprising a fixed angle secondary collimator configured to allow the first scatter radiation and the second scatter radiation to reach said scatter detector.

21. An XDI system in accordance with claim 9, wherein said X-ray source comprises an X-ray multisource comprising an array of discrete electron emitters.

22. An XDI system in accordance with claim 21, wherein said X-ray source is configured to one of magnetically and electrostatically deflect said discrete electron emitters.
